(19) United States
(12) Patent Application Publication
(10) Pub. No.: US 2019/0352167 A1
(43) Pub. Date: Nov. 21, 2019

(54) Method for Operating a Beverage Dispenser, Method for Dispensing a Beverage, and Beverage Dispenser

(71) Applicant: BSH HAUSGERAETE GMBH, Muenchen (DE)

(72) Inventor: EVGENI REHFUSS, MUENCHEN (DE)

(21) Appl. No.: 15/982,384

(22) Filed: May 17, 2018

(51) Int. Cl. B67D 1/08; A47J 31/40

(52) U.S. Cl. CPC B67D 1/0881; B67D 2001/0811; A47J 31/407; B67D 1/0888

(57) ABSTRACT

A method for operating a beverage dispenser includes: receiving a request to dispense a beverage; receiving information enabling dispensing the beverage from the beverage dispenser for a pre-determined validity period; and checking whether the current time is within the pre-determined validity period, and if so, dispensing the beverage. A method for dispensing a beverage from a beverage dispenser, the method includes the steps of: by a requesting entity: sending a request for issuing first information enabling dispensing beverage from the beverage dispenser for a pre-determined validity period; by an issuing entity: receiving the request for issuing and issuing the first information; by the beverage dispenser: receiving a request for dispensing a beverage and receiving second information regarding the dispensing request; and checking whether the second information matches the first information and whether the current time is within pre-determined validity period, and if so, enabling dispensing the beverage.

The invention relates to a method for operating a beverage dispenser. The invention further relates to a method for dispensing a beverage from a beverage dispenser. The invention also relates to a beverage dispenser, comprising a dispensing unit for dispensing a beverage and at least one information receiving unit for acquiring information. The invention is particularly useful for beverage dispensers using single-use beverage containers.

Some beverage dispensers are adapted to dispense a beverage based on a single-use beverage container which is to be inserted into the dispenser prior to dispensing. The beverage container comprises some ingredients of the beverage to be dispensed. The dispensing unit may provide one or more basic ingredients of the beverage like sparkling water, fruit juice etc. while the beverage container provides additional flavors etc. When dispensing the beverage, the beverage container is opened such that its ingredients are released to be mixed with the ingredients provided by the beverage dispenser, e.g. within a mixing chamber. If the beverage is an alcoholic beverage, the alcohol may be provided by the beverage dispenser or may be included in the beverage container.

At present, beverage containers used for dispensing an alcoholic beverage are under control of qualified staff (operator staff). Before selling or handing out a beverage container, staff checks or verifies fulfillment of certain (e.g. legal) requirements like minimum age and level of intoxication of the customer. The consumer may then insert the beverage container into the beverage dispenser to make or produce and then dispense an alcoholic beverage. However, this approach does not prevent the customer from collecting one or more beverage containers to be used at times at which alcoholic beverages may not be served, at which the consumer is inebriated, or which are of such a number that they could collectively lead to severe alcoholization of the customer. This approach also does not prevent the customer from later reselling or handing out the beverage container to inebriated or underage persons.

Beverage containers using single-use beverage containers are generally known. For example, US 2016/0255991 A1 discloses a device for dispensing a beverage includes a plurality of replaceable reservoirs, each respectively configured to contain a respective liquid ingredient. Multiple pumps are each operatively connected to a respective reservoir and configured to transfer the respective liquid ingredient from one or more of the reservoirs. Multiple nozzles are operatively connected to the plurality of pumps and configured to receive a liquid ingredient from at least one of the plurality of pumps. A single use beverage cartridge includes a second liquid ingredient and is configured to receive the liquid ingredient dispensed from the at least one of the plurality of pumps to generate a mix of the liquid ingredient with the second ingredient.

WO 2017/062656 A1 discloses a method, device, and system for in-room wine purchasing and/or dispensing. In one embodiment, an administrator/user of a property management system may be able to restrict the purchase or dispensing of wine on a given wine dispensing device via a platform management subsystem and/or a user interface of the wind dispensing device. These manual restrictions may be employed in place or in addition to restricting instructions generated based on the obtained alcohol-related policy and/or regulatory information. Further, these manual restrictions may be enforced in the form of drinking hours specified by property specific policies and/or circumstances. These manual restrictions may be specified via any granularity or increment of time (e.g., hours in a day, days in a week, etc.). Also, a parental lock may be employed. The parental lock may be a logical locking mechanism imposed to inhibit/prevent the consumption of wine by underage guests. The wine dispensing device may be programmed with a parental lock using. For example, upon determining that a parental lock has been enabled, the interacting guest user is prompted via the touchscreen for a parental lock code. In one embodiment, the parental lock code may be an authorization code in the form of a sequence of numbers of any specified length. In one embodiment of the invention, the PLC may have been selected by an adult guest occupying the room. In another embodiment of the invention, the parental lock code may have been generated by a staff member or the property management system during the check-in process at the property.

US 2011/0298583 A1 discloses methods, systems, and apparatus, including computer programs encoded on a computer storage medium, for control of beverage dispensing. In one aspect, authorization data specifying that a beverage dispensing node is authorized to be activated are received. Activation data that request activation of the node are also received, where activation of the node causes a valve that controls flow of fluid to a beverage dispenser to be opened. A determination is made that the activation data are associated with a user identifier for an enabled user, where an enabled user is a user that has been enabled to activate the node. In response to receipt of the authorization data and the activation data a valve that controls flow of fluid to the beverage dispenser is opened. Data (e.g., de-authorization or de-activation data) specifying that an activated beverage dispensing apparatus be de-activated can also be received. In response to receipt of the data, the valve can be closed.

It is the object of the present invention to at least partially overcome the problems associated with the prior art. It is a particular object of the present invention to reduce the opportunity to circumvent requirements for consuming alcoholic beverages like meeting minimum age requirements and requirements regarding a level of alcoholization.

The object is achieved according to the features of the independent claims. Advantageous embodiments can be found, e.g., in the dependent claims and/or in the description.

In one embodiment, the object is achieved by a method for operating a beverage dispenser, the method comprising the steps of:
receiving a request to dispense a beverage;
receiving information enabling dispensing the beverage from the beverage dispenser for a pre-determined validity period;
checking whether the current time is within the pre-determined validity period, and if so, dispensing the beverage.

This method gives the advantage that the time span or period available to a potential consumer to dispense the beverage is limited. Thus, the consumer is forced to dispense the beverage within the pre-determined validity period. If the beverage dispenser uses single-use beverage containers, this prevents holding back the container for use at a later time. This method also makes it considerably harder to collect multiple containers to be used in a short time and to resell or hand out this beverage container to underage persons for consumption.

Generally, the beverage dispenser may use single-use beverage containers but is not restricted to such a use. The beverage dispenser may be a self-serve beverage dispenser.

The beverage container may also be called a beverage ingredient container, a beverage capsule, a beverage cartridge, etc. Particularly, the beverage container contains only part of the ingredients needed to produce the final beverage.

The request to dispense the beverage may be generated or initiated by a consumer, e.g., by operating a man machine interface of the beverage dispenser, by inserting a beverage container into the beverage dispenser, etc.

The received information may generally be any kind of information that enables dispensing of a beverage for or within a pre-determined validity period. For example, the information may be printed information, displayed information (e.g., displayed on a display of a mobile terminal) and/or wireless information (e.g., information obtained by the beverage dispenser over the air in form of a data sequence, e.g. an NFC code, an RFID code). The beverage dispenser, in particular its man machine interface, may comprise one or more information receiving units to receive the information. The at least one information receiving unit may, e.g., comprise a (physical or virtual) keyboard, an optical code reader (e.g., a barcode scanner, a QR code scanner, etc.), a wireless reader (e.g., an RFID reader, an NFC reader, etc.) and/or a wireless communication module (e.g. a Bluetooth module, an LTE module, a WiFi module etc.).

Particularly, the received information may be in form of a symbol code (e.g., comprising letters, numbers and/or special characters like the “pound sign” etc.), an optical machine-readable code (e.g., a barcode, a QR code, etc.), a wireless code (e.g., an NFC code or an RFID code), or a combination thereof.

However, if the received information is not in the form that it would enable dispensing the beverage from the beverage dispenser (incorrect information), it may be rejected. The information may be or may also be called a “token”, “code”, “ticket”, etc.

The pre-determined validity period may be the period starting from requesting or from issuing the information. The validity period may be defined by a starting time (e.g. “8:12 p.m.”) and a duration (e.g., “1 hour”) and/or by an end time (e.g., “9:12 p.m.”). The validity period may also comprise a date (e.g., “May 12, 2018”). In analogy, the current time may comprise the time of the day and potentially the date.

Requesting to issue the information may be initiated by operator staff after verifying fulfillment of certain requirements like age requirements or lack of signs of drunkenness. To this effect, operator staff may use a requesting entity like a terminal, e.g. an electronic register. The requesting entity may be specifically authorized to request the first information.

In one embodiment, issuing the information may comprise generating and providing the information. Providing may comprise sending or transmitting the information and/or storing the information for look-up.

The pre-determined validity period may, e.g., be a fixed period, may be dependent on the type of beverage to be dispensed, and/or may be set by the operator staff.

If the current time is not within the pre-determined validity period, dispensing the beverage is denied. In this case, the consumer may return to operator staff and ask for issuing another information enabling dispensing the beverage. Operator staff may initiate requesting to issue new information after again verifying fulfilment of requirements like age or signs of drunkenness.

The checking step may be performed by the beverage dispenser or by an entity connected to the beverage dispenser, in particular by an entity connected to the beverage dispenser via a data network.

In one embodiment, the checking is autonomously performed by the beverage dispenser. This may be particularly simple to implement if the pre-determined validity period is comprised, e.g. encoded, in the information. In this case, the beverage dispenser may be adapted to extract the pre-determined validity period from the information and compare the current time with the pre-determined validity period. For example, a consumer is handed a piece of paper on which the information including the pre-determined validity period in an encoded form is printed, e.g., as a barcode or a QR code. The consumer may then approach a beverage dispenser and let the beverage dispenser receive the information, e.g. by inputting the code via a keypad, by letting the beverage dispenser scan the barcode or QR code, etc. The beverage dispenser then uses the pre-determined validity period included to check if the current time is within the pre-determined validity period. If so, the beverage dispenser allows dispensing a beverage, if not, the dispensing is denied.

Instead of a printed barcode or QR code, a transponder card may be encoded with the information which is readable by the beverage dispenser. The transponder card may be a card handed out for this occasion or may be a consumer's room card etc. The transponder card may comprise an NFC or an RFID transponder. Alternatively, the information including the pre-determined validity period is transferred to a mobile terminal of the consumer, e.g., a smartphone. To this effect, the mobile terminal may be equipped with a suitable application program or “app”.

It is an embodiment that the checking step comprises connecting to an issuing entity via a data network and comparing the received information with information issued and stored by the issuing entity, and if the information coincides, dispensing the beverage. This gives the advantage that the checking process may be implemented in a particularly flexible and easy to adapt manner. This embodiment is also particularly safe against tampering.

There are several options to compare the received information with the information issued and stored by the issuing entity. One option comprises that the beverage dispenser sends the received information to the issuing entity, the issuing entity searches for a match with stored information, and if there is a match the issuing entity determines the related pre-determined validity period (e.g. by looking up the pre-determined validity period in a table linking the issued information with the respective pre-determined validity period), checks if the current time is within the pre-determined validity period, and if yes, signals the beverage dispenser to allow dispensing a beverage. Another option comprises that the beverage dispenser looks up information stored in the issuing entity, and if there is a match with the received information, looks up the respective pre-determined validity period stored in the issuing entity, checks if the current time is within the pre-determined validity period, and if so, dispenses or allows dispensing the beverage. In the above cases, the pre-determined validity period may be stored as a separate entry from the issued information. Alternatively, the pre-determined validity period may be intrinsically included in the information. It is a particularly easy to implement and to perform option that the issued information is only stored for the pre-determined validity period. Then, if there is a match between the information received by the beverage dispenser and the issued information, the dispensing of a beverage is allowed. In this option there is advantageously no need to check the current time with respect the pre-determined validity period after finding a match. Rather, finding a match already includes or implies that the request to dispense a beverage has been made within the pre-determined validity period.

The issuing entity may be any entity that issues the information, in particular upon request of operator staff. The issuing entity may be implemented in hardware, software, or both. For example, the issuing entity may be a network server on which software is stored that enables the server to perform issuing the information. In another variant, the issuing entity may be a network-based or cloud-based software application or module.

The object is also achieved by a method for dispensing a beverage from a beverage dispenser, the method comprising the steps of:
by a requesting entity: sending a request to an issuing entity for issuing first information enabling dispensing beverage from the beverage dispenser for a pre-determined validity period;
by the issuing entity: receiving the request and issuing the first information;
by the beverage dispenser: receiving a request for dispensing a beverage and receiving second information regarding the dispensing request; and
checking whether the second information matches the first information and whether the current time is within pre-determined validity period, and if so, enabling dispensing the beverage.

This method, too, gives the advantage that the possibility of a consumer/user of the beverage dispenser to dispense the beverage is time-limited. Thus, the consumer is forced to dispense the beverage within the pre-determined validity period which prevents holding back the container for use a later time. If the beverage dispenser uses beverage containers (also called capsules or cartridges etc.), this method also makes it considerably harder to collect multiple containers to be used in a short time or to resell or hand out beverage containers to unauthorized, e.g. underage, persons.

In an embodiment, the requesting entity may be a terminal operated by operating staff, e.g. an electronic register. The requesting entity may be specifically authorized to request the first information.

In another embodiment, the requesting entity may be the consumer. For example, the consumer may buy a beverage container and try to activate the dispensing of the respective beverage by sending a request to the issuing entity. This activation may be performed using a consumer's mobile terminal, e.g. using a respective application program or “app”. However, to prevent intoxication, the pre-determined validity period may be set by the issuing entity such that dispensing the respective beverage is only possible for pre-defined validity periods (e.g. not between 1 a.m. and 9 a.m.) and/or that only a certain number of beverages associated with a certain consumer may be consumed within the validity period. These checks may, in general, also by performed if the request for issuing first information is performed by the operating staff. The consumer may have been age-verified to use this function.

The issuing entity may be connected to the requesting entity via a data network. For example, the issuing entity may be a server on which software is stored that enables the server to perform the respective step(s) of the method above. In another variant, the issuing entity may be a network-based or cloud-based software application or module.

The beverage dispenser may receive a request from a consumer for dispensing a beverage and may receive second information from the consumer regarding the dispensing request. In one embodiment, receiving the second information corresponds to receiving the request for dispensing.

The second information may generally be any information that the consumer provides to the beverage dispenser to enable dispensing the beverage.

The checking may, e.g., be performed by the beverage dispenser, the issuing entity, or both.

It is an embodiment that issuing the first information comprises generating the first information and providing the first information to the requesting entity. For example, operating staff may operate a terminal to request the first information, the terminal sends the request to the issuing entity, the issuing entity receives the request and issues the first information by generating the first information and sending it back to the requesting entity.

It is an embodiment that the requesting entity prints the first information after having it received from the issuing entity. The first information may be printed, e.g., in form of a barcode or QR code, and handed to the consumer by the operating staff. It is also an embodiment that the requesting entity stores the first information on a transponder card, e.g. an NFC or RFID card. Alternatively, the requesting entity may provide the first information to a consumer's mobile terminal, e.g. via wireless data transfer, e.g. in form of a QR code, an NFC code, etc.

It is an embodiment that the first information is in form of a symbol code comprising letters, numbers and/or special characters like the “pound sign” etc. In particular, the symbols may be available for input into the beverage dispenser via a keypad of the beverage dispenser. This embodiment is particularly useful if the first information is handed to the consumer in printed form.

It is an embodiment that the first information is in form of an optical machine-readable code, e.g., a barcode, a QR code, etc. This gives the advantage that the first information may be received by the beverage dispenser in a particularly simple and error-free manner. To optically read the optical machine-readable code, the beverage dispenser may be equipped with a suitable reader or scanner, e.g. a barcode reader or barcode scanner. The optical machine-readable code may be printed on a piece of paper or be displayed on a mobile terminal.

It is an embodiment that the first information is in form of a wireless code, e.g., an NFC code, a RFID code, etc.). This wireless code may in particular be sent to a consumer's mobile terminal. The mobile terminal may be a laptop computer or may be a mobile device like a tablet PC, a smartphone, a phablet, a smart watch, etc.

It is an embodiment that issuing the first information comprises generating the first information and providing the first information to a pre-defined mobile terminal. This mobile terminal may be a consumer's mobile terminal. In general, issuing the first information may comprise issuing the information to an entity different from the requesting entity. For example, operating staff may operate the terminal to request the first information and also to provide address information about an address related to a consumer's mobile terminal (e.g. an email address, a mobile phone number), the terminal then sends the request and the address information to the issuing entity, where it is received. The issuing entity then issues the first information by generating the first information and sending it to the entity specified by the address information, e.g., the consumer's mobile terminal. Sending the first information may include sending an email, an SMS, an MMS, any other type of message (e.g. a WhatsApp message etc.). At the consumer's mobile terminal, the received first information is stored (e.g., in form of a barcode, a QR code, an NFC code, etc.) for later interaction with the beverage dispenser.

It is an embodiment that issuing the first information comprises generating the first information and storing the first information by the issuing entity. This is particularly advantageous if the checking step is performed by or together with the issuing entity.

It is an embodiment that the issuing entity stores the issued information only for the pre-determined validity period. This provides a particularly simple and user-friendly checking step. Particularly, there is advantageously no need to check the current time with respect to the pre-determined validity period after finding a match. Rather, finding a match already includes or implies that the request to dispense a beverage has been made within the pre-determined validity period.

It is an embodiment that the beverage dispenser is adapted to dispense a beverage based on a beverage container to be inserted into the beverage dispenser by a consumer prior to dispensing. The above described method is particularly advantageous to prevent misuse of such containers. In one aspect, operating staff may hand out a beverage container to a consumer together with the first information, e.g. a paper slip with the first information printed on it.

The beverage container may be a single-use container. The beverage container may be disposable.

In an embodiment of the invention:
the request for issuing the first information comprises an ID of the beverage container;
issuing the first information comprises storing the ID for the pre-determined validity period;
receiving the second information comprises acquiring the ID of a beverage container; and
checking comprises matching the ID acquired by the beverage dispenser with ID stored in the issuing entity, and if there is a match, dispensing the beverage.

This advantageously allows linking the first information and the ID, thus enabling an even more effective control regarding dispensing the beverage container. It is also particularly easy to implement and to use. For example, for the request to comprise the ID of the beverage container, operating staff may scan the ID of the beverage container to be handed over to a consumer. This ID is then provided to the issuing entity. In a particularly convenient embodiment, the issuing entity issues the first information by simply storing it only for the pre-determined validity period. If the consumer then approaches a beverage dispenser to dispense the beverage associated with a beverage container, the beverage dispenser may scan the ID of the beverage container inserted or to be inserted by the consumer. Then, the ID scanned by the beverage dispenser is compared with IDs stored by the issuing entity. If there is a match, dispensing a beverage using the scanned beverage container is enabled.

The ID may be attached to the beverage container, e.g., printed or etched on it, glued to it etc. The ID may be in encoded form, e.g., a barcode or a QR code. In an embodiment, the ID is encoded as an RFID code.

It is an embodiment that the ID designates the type of beverage that may be dispensed using the beverage container (e.g., “Pina Colada”, “Lime Cooler” etc.).

It is an embodiment that the ID is a unique or quasi-unique ID. This allows for a particularly effective prevention of misuse of beverage containers. Particularly in this case, it is an embodiment that the ID is part of or is the first information. This gives the advantage that the first information does not need to be calculated and distributed.

However, it is generally possible that the first information is based on the ID (derived or calculated from the ID) but is not identical to the ID. For example, the first information may be a combination of the ID and the predetermined validity period. Also, the first information may comprise further information like a transaction number, an ID of the requesting entity, an ID of the operating staff initiating the request, etc.

It is an embodiment that the checking on matching IDs is only performed if the ID is associated with pre-defined beverages or types of beverages, e.g. with alcoholic beverages. This simplifies dispensing beverages that do not need to fulfill certain requirements, e.g., lemonades, ice tea, flavored water, etc. To implement this embodiment, the beverage dispenser may be adapted to differentiate between container IDs that require checking and container IDs that do not. If a beverage container comprises a container ID (second information) that does not need to be checked against an issued/stored container ID (first information), the beverage dispenser may enable dispensing without checking. In this case, there is also no need to request dispensing a beverage and issuing the first information.

It is an embodiment that the request to dispense a beverage comprises the pre-determined validity period. This gives the advantage that the pre-determined validity period may be set individually, e.g., by the operating staff and/or depending on the type of beverage. For example, shorter validity periods may be set for beverages having a high alcohol content as compared to low alcohol drinks like beer. Also, operating staff may set shorter validity periods for certain consumers, e.g., bachelor parties.

The object is also achieved by a beverage dispenser, comprising: a dispensing unit for dispensing a beverage; and at least one information receiving unit for acquiring information, wherein the beverage dispenser is adapted to acquire, via the at least one information receiving unit, information enabling dispensing the beverage from the beverage dispenser for a pre-determined validity period, and to check whether the current time is within the pre-determined validity period, and if so, to dispensing the beverage.

It is an embodiment that the beverage dispenser further comprises a communication module for communication via a data network, wherein the beverage dispenser is further adapted to check whether the current time is within the pre-determined validity period by comparing the information acquired via the least one information receiving unit with information stored by an issuing entity, the issuing entity being connected to the beverage dispenser via the data network.

It is an embodiment that the beverage dispenser is adapted to dispense a beverage using a single-use beverage container inserted into the dispensing unit prior to dispensing.

The beverage dispenser may be further implemented or embodied in analogy to the above described methods.

The object may also be achieved by a beverage dispensing system, comprising at least one beverage dispenser, at least on requesting entity and an at least on issuing entity, as described above.

The invention may generally be based on the idea that dispensing a beverage, in particular an alcoholic beverage, from the beverage dispenser may only be permitted for a limited period of time. This period (the “pre-determined validity period”) starts with requesting or issuing the first information. The consumer must dispense the beverage within the pre-determined validity period, dispensing at other times is denied. The requesting may be restricted to be performed by operating staff of commercial establishments (e.g., hotels, restaurants, cafés, etc.).

The above described features and advantages of the invention as well as their kind of implementation will now be schematically described in more detail by at least one embodiment in the context of one or more figures.

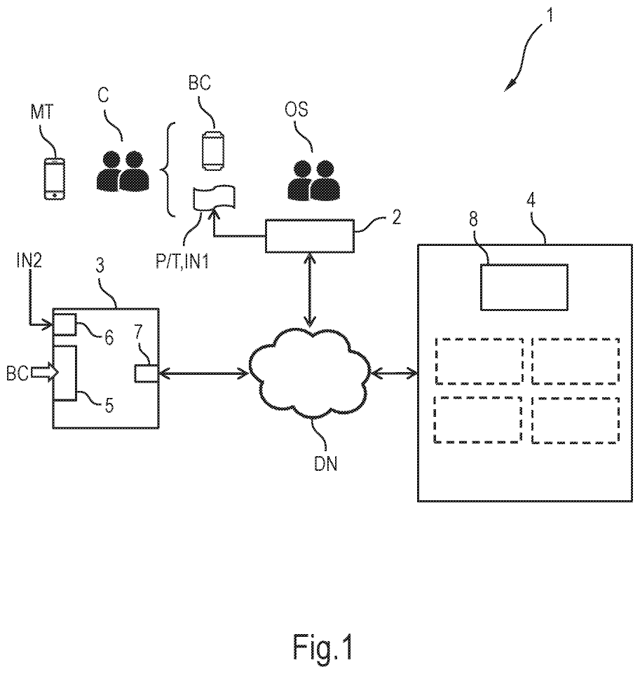

FIG. 1 shows a beverage dispensing system according to one possible embodiment;

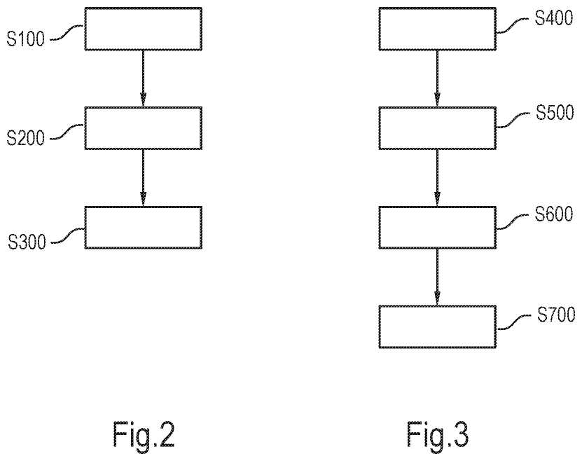

FIG. 2 shows process steps of a method for operating the beverage dispenser; and

FIG. 3 shows process steps of a method for dispensing a beverage from the beverage dispenser.

FIG. 1 shows a beverage dispensing system 1 according to a first embodiment comprising a web-enabled requesting entity 2, a web-enabled beverage dispenser 3 and a web-enabled issuing entity 4. The requesting entity 2 is connectable to the issuing entity 4 via a data network DN and the beverage dispenser 3 is connectable to the issuing entity 4 via the data network DN.

The requesting entity 2 may be a terminal operated by operating staff OS, e.g. an electronic register, an ordering device, etc. The requesting entity 2 may be specifically authorized to communicate with the issuing entity 4.

The beverage dispenser 3 comprises a dispensing unit 5 for dispensing a beverage. To this effect, the dispensing unit 5 is adapted to receive a beverage container BC from a user/consumer C. The beverage dispenser 3 further comprises at least one information receiving unit 6, e.g. a keypad, an optical code scanner and/or a wireless code reader for acquiring “second” information IN2. The beverage dispenser 3 is adapted to acquire, via the at least one information receiving unit 6, the second information IN2, to check whether this second information IN2 is information enabling dispensing a beverage from the beverage dispenser 3 for a pre-determined validity period, and to check whether the current time is within the pre-determined validity period, and if so, to enable dispensing the beverage. The beverage dispenser 3 further comprises at least one communication module 7 for communication via the data network DN. The communication module 7 may be a wire bound communication module 7, e.g., an Ethernet module, and/or a wireless communication module 7, e.g., a WLAN module, an LTE module, or a Bluetooth module.

The issuing entity 4 may be a server or a cloud-based web application. The issuing entity 4 may comprise one or more modules, in particular, software modules representing respective functions, of which one module 8 is adapted to issue “first” information IN1, as will be explained in greater detail below. The issuing entity 4 may comprise further modules or functions, as indicated by the dashed rectangles, e.g., relating to content management, to firmware update for the beverage dispenser 3, to machine diagnostics of the beverage dispenser 3, to stock check & orders for the beverage dispenser 3, to statistical analysis regarding use of the beverage dispenser 3, to remote diagnostics of the beverage dispenser 3 with audio/video streaming and/or to maintaining a consumer preference database.

Particularly, the beverage dispenser 3 may be adapted to check whether the current time is within the pre-determined validity period by comparing the second information IN2 acquired via the least one information receiving unit 6 with the first information IN1 stored by the issuing entity 4.

The issuing entity 4 may issue the first information IN1, e.g., by storing it, by generating and storing it, by generating and sending it to the requesting entity 2, and/or by generating and sending it to a mobile terminal MT of the consumer C, e.g. via SMS or another messaging service. If the first information IN1 is sent to the requesting entity 2, the requesting entity 2 may transfer the first information IN1 to the mobile terminal MT of the consumer C, may print it on a slip of paper P, or hand out a transponder card T (e.g. an RFID card) comprising the first information IN1.

FIG. 2 shows process steps of one possible method for operating the beverage dispenser 3, comprising:
a step S100 of receiving, by the beverage dispenser 3, a request to dispense a beverage;
a step S200 of receiving, by the beverage dispenser 3, (second) information IN2 potentially enabling dispensing the beverage from the beverage dispenser 3 for a pre-determined validity period; and
a step S300 of checking whether the current time is within pre-determined validity period, and if so, dispensing the beverage. Step S300 may be preceded by or comprise a step of checking whether the received information IN2 is of a form and/or content that it potentially enables dispensing the beverage from the beverage dispenser 3 for the pre-determined validity period.

FIG. 3 shows process steps of one possible method for dispensing a beverage from the beverage dispenser 3, comprising:
a step S400 of sending, by the requesting entity 2: a request for issuing the first information IN1 to the issuing entity 4;
a step S500 of receiving, by an issuing entity 4: receiving the request for issuing the first information IN1 and then issuing the first information IN1;
a step S600 of receiving, by the beverage dispenser 3, a request for dispensing a beverage and receiving second information IN2 related to the dispensing request; and
a step S700 of checking whether the second information IN2 matches the first information IN1 and checking whether the current time is within pre-determined validity period associated with the first information IN1, and if so, dispensing the beverage or enabling dispensing the beverage.

Step S600 may be identical to step S200. Step S300 may comprise step S700, or vice versa.

Under one aspect, issuing the first information IN1 according to step S500 comprises generating the first information IN1 and providing the first information to the requesting entity 2. In one variant, the requesting entity prints the first information IN1 onto, e.g., the slip of paper P. In particular, the first information IN1 may be printed in encoded form, e.g. in form of a symbol code or an optical machine-readable code like a barcode or a QR code.

In another variant, the requesting entity 2 stores the first information IN1 on a portable storage medium, e.g., a transponder card T, especially a room card. The portable storage medium may be wirelessly readable by the information receiving unit 6, e.g. via RFID. The portable storage medium may thus comprise an NFC or RFID transponder.

In yet another variant, the requesting entity 2 stores the first information IN1 on/transfers the first information IN1 to the consumer's mobile terminal MT. consumer's mobile terminal MT may provide the first information IN1 optically (e.g. by displaying the first information IN1 on its display) or by radio transmission (e.g. by transferring the first information IN1 via NFC).

In even another variant, the first information IN1 is provided directly from the issuing entity 4 to the user's mobile terminal MT via the data network DN.

With the first information IN1 at hand, the consumer C may now walk to a beverage dispenser 3 (i.e., a self-serve beverage dispenser), insert the beverage container BC and input the first information IN1 into the information receiving unit 6. The first information IN1 thus corresponds to the second information IN2 received by the beverage dispenser 3.

In one variant, the first information IN1 comprises the pre-determined validity period. Then, the beverage dispenser 3 may be adapted to perform step S300 itself, i.e., without interaction with issuing entity 4.

In another variant, issuing the first information IN1 comprises generating the first information IN1 and storing the first information IN1 by the issuing entity 4. Upon receiving the second information IN2, it is checked in step S700 whether the second information IN2 matches the first information IN1. If so, it is checked whether the current time is within pre-determined validity period associated with the first information IN1, and if so, dispensing the beverage or enabling dispensing the beverage. If the second information IN2 does not match stored first information IN1, dispensing the beverage is denied. The checking in step S700 may be performed as a push operation (in which, e.g., the second information IN2 is transmitted to the issuing entity 4 which checks for matching first information IN1 and which checks whether the current time is within pre-determined validity period associated with the first information IN1 and which then sends back the results to the beverage dispenser 3) or as a pull operation (in which, e.g., the beverage dispenser 3 looks up a list of first information IN1 stored by the issuing entity 4 and checks whether the current time is within pre-determined validity period associated with the first information IN1). Thus, the pre-determined validity period may be stored together with the corresponding first information IN1.

In yet another variant, issuing the first information IN1 comprises generating the first information IN1 and storing the first information IN1 by the issuing entity 4 only for the pre-determined validity period. In this variant, checking whether the second information IN2 matches the first information IN1 and checking whether the current time is within pre-determined validity period associated with the first information IN1 is the same operation: if the checking step S700 finds a match of the second information IN2 and a first information IN1 stored by the issuing entity 4, the current time is de facto within pre-determined validity period. Likewise, if the checking step S700 finds no match between the second information IN2 and first information IN1 stored by the issuing entity 4, the current time is outside the pre-determined validity period.

In even another variant, the first information IN1 is or corresponds to an ID associated with the beverage container. In this case, step S400 may simply comprise sending the ID to the issuing entity 4 to be stored for the pre-determined validity period. In step S500, issuing the first information IN1 may only comprise storing the ID for the pre-determined validity period. The requesting entity 2 does not need to explicitly hand out any first information IN1 to a customer C but only the beverage container BC comprising the ID. In step S600, the receiving the second information IN2 may comprises reading a beverage container's ID. The checking step S700 may then only comprise checking the ID received by the beverage dispenser 3 against ID(s) stored by the issuing entity 4, e.g., in analogy to the step described above.

It will be readily understood that the invention is not restricted to the described embodiments.

### LIST OF REFERENCE SIGNS

1 beverage dispensing system
2 requesting entity
3 beverage dispenser
4 issuing entity
5 dispensing unit
6 information receiving unit
7 communication module
8 issuing software module
BC beverage container
C consumer
DN data network
IN1 first information
IN2 second information
MT Mobile terminal
OS operating staff
P paper
S100-S700 method steps
T transponder card

1. A method for operating a beverage dispenser, the method comprising the steps of:
providing the beverage dispenser as a self-serve beverage dispenser using single-use beverage cartridges;
receiving a request to dispense a beverage;
receiving information enabling dispensing the beverage from the beverage dispenser for a pre-determined validity period being a period starting from a time at which the request to dispense the beverage is received or a time at which the information enabling dispensing of the beverage is received;
checking whether the current time is within the pre-determined validity period, and if so, dispensing the beverage.

2. The method according to claim 1 wherein the received information includes an ID of a single-use beverage cartridge, and wherein the checking step comprises connecting to an issuing entity via a data network and comparing the ID of the single-use beverage cartridge with an ID of a single-use beverage cartridge issued and stored by the issuing entity, and if the information coincides, dispensing the beverage.

3. A method for dispensing a beverage from a beverage dispenser, the method comprising the steps of:
providing a beverage dispenser configured to dispense a beverage using a single-use beverage container configured to be inserted into the beverage dispenser prior to dispensing;
by a requesting entity: sending a request for issuing first information enabling dispensing beverage from the beverage dispenser for a pre-determined validity period being a period starting from requesting or issuing the first information, wherein the request for issuing the first information includes an ID of the single-use beverage container;
by an issuing entity: receiving the request for issuing and issuing the first information, wherein the issuing of the first information includes generating the first information and storing the first information only for the pre-determined validity period, and wherein the ID of the single-use beverage container is stored only for the pre-determined validity period;
by the beverage dispenser: receiving a request for dispensing a beverage and receiving second information regarding the dispensing request, wherein receiving the second information includes acquiring an ID of a single-use beverage container; and
checking whether the second information matches the first information and whether the current time is within pre-determined validity period, and if so, enabling dispensing the beverage, wherein the checking includes matching the ID that is acquired by the beverage dispenser with the ID stored in the issuing entity.

4. The method according to claim 3, wherein issuing the first information comprises generating the first information and providing the first information to the requesting entity.

5. The method according to claim 4, wherein the requesting entity prints the first information or stores the first information on a transponder card.

6. The method according to claim 5, wherein the first information is in form of a symbol code, an optical machine-readable code, or a combination thereof.

7. The method according to claim 3, wherein issuing the first information comprises generating the first information and providing the first information to a pre-defined mobile device.

8. The method according to claim 7, wherein the first information is in form of a symbol code, an optical machine-readable code, a wireless code, or a combination thereof.

9-11. (canceled)

12. The method according to claim 3,
wherein
issuing the first information comprises issuing first information that is based on the ID.

13-14. (canceled)

15. The method according to claim 3, wherein the request to dispense a beverage comprises the pre-determined validity period.

16. A beverage dispenser, comprising:
a dispensing unit configured to dispense a beverage using a single-use beverage container configured to be inserted into the dispensing unit prior to dispensing; and
at least one information receiving unit for acquiring information;
wherein the beverage dispenser is adapted to:
acquire, via the at least one information receiving unit, information enabling dispensing the beverage from the beverage dispenser for a pre-determined validity period being a period starting from a time at which a request to dispense the beverage is received or a time at which the information enabling dispensing of the beverage is received, wherein the information enabling dispensing includes an ID of a single-use beverage container; and
dispense the beverage upon successfully checking that the current time is within the pre-determined validity period and that the ID acquired by the beverage dispenser matches an ID stored in an issuing entity.

17. The beverage dispenser according to claim 15, further comprising a communication module for communication via a data network, wherein the beverage dispenser is further adapted to check whether the current time is within the pre-determined validity period by comparing the information acquired via the least one information receiving unit with information stored by an issuing entity, the issuing entity being connected to the beverage dispenser via the data network.

18. (canceled)
